(19) United States
(12) Patent Application Publication
(10) Pub. No.: US 2008/0070023 A1
(43) Pub. Date: Mar. 20, 2008

(54) Polyamide composition for blow molded articles

(76) Inventor: Georgios Topoulos, Geneva (CH)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/985,677

(22) Filed: Nov. 16, 2007

Related U.S. Application Data
(63) Continuation of application No. 10/819,766, filed on Apr. 7, 2004.
(60) Provisional application No. 60/462,716, filed on Apr. 14, 2003.

(51) Int. Cl. B32B 27/34; B29C 49/04; C08G 69/00; C08K 5/13; C08K 5/16; C08K 5/49

(52) U.S. Cl. 428/220; 264/540; 524/147; 524/186; 524/323

(57) ABSTRACT

High temperature polyamide resin compositions for blow molding and articles blow molded from such compositions are provided. The blow molded articles exhibit excellent heat resistance, chemical resistance, and dimensional stability. The composition has a melting point of at least 275° C. and a glass transition temperature of at least 60° C. The composition comprises an aromatic polyamide, an impact modifier, and a stabilizer. The aromatic polyamide is a polymer or copolymer having repeating units derived from a carboxylic acid component and an aliphatic diamine component, the carboxylic component being terephthalic acid or a mixture of terephthalic acid and one or more other carboxylic acids, and the aliphatic diamine component being hexamethylene diamine or a mixture of hexamethylene diamine and 2-methyl pentamethylene diamine or 2-ethyltetramethylene diamine. The impact modifier is selected from the group of (i) ethylene polymers and copolymers grafted with carboxylic acid, an anhydride thereof, maleimide or an epoxy compound; (ii) olefin/arcylic acid/anhydride terpolymers and ionomers; and (iii) styrenic thermoplastic elastomers grafted with an anhydride of a carboxylic acid. The stabilizer is selected from the group of (i) phosphite and phosphonite stabilizers; (ii) hindered phenol stabilizers; (iii) hindered amine stabilizers; and (iv) aromatic amine stabilizers.

### CROSS REFERENCE TO RELATED APPLICATIONS

This application claims the benefit of U.S. application Ser. No. 10,819,766, filed Apr. 7, 2004, which is a non-provisional of U.S. Provisional Application No. 60/462,715 filed Apr. 14, 2003.

### BACKGROUND

1. Field of the Invention

The present invention relates to polyamide resin compositions and articles that are blow molded from such compositions. More particularly, the invention relates to articles blow molded from polyamide resin compositions, which articles exhibit excellent heat resistance, chemical resistance, dimensional stability, and mechanical properties, and are suitable for a wide range of applications, including parts used in automobiles, electrical and electronic parts, furniture, and appliances.

2. Description of the Related Art

Conventional aliphatic polyamide resins include nylon 66, nylon 6, and nylon 612. The blow molding of articles comprised of such aliphatic polyamides is known. Nylon 6 and nylon 66 are the polyamide resins most commonly used for producing blow molded articles. During blow molding, a molten hollow parison is extruded vertically through a die. The molten parison is captured by a mold, pinched at the bottom and top, inflated from its interior such that the parison expands to assume the shape of the surrounding mold cavity, and then cooled. The mold is then opened for removal of the solidified hollow article. Blow molding can be used to produce a wide variety of polyamide articles, including bottles and automobile parts such as air ducts and coolant pipes. However, the mechanical properties, such as strength and stiffness, of nylon 6 and nylon 66 can change significantly upon the absorption of moisture. In addition, parts blow molded from nylon 6 and nylon 66 can deform or melt under high temperature conditions and they may experience stress cracks upon exposure to chemicals.

In order to improve the chemical resistance, in particular, the resistance against calcium chloride, and other inorganic salts, nylon 612 or a mixture of nylon 612 and nylon 66 has been used in blow molding. However, nylon 612 and mixtures containing nylon 612 exhibit reduced heat resistance.

Some parts of home appliances and power tools, as well as many automotive parts, must have the ability to withstand high temperatures experienced in use or during the manufacturing process. Regarding automotive applications, polyamide resins, and in particular, reinforced polyamide resins, are used in manufacturing engine covers, parts connected directly to the engine covers such as connectors and air intake manifolds, and other engine body parts where high operating temperatures are experienced. For cost reasons, it is desirable to manufacture many of these parts by blow molding methods. However, parts blow molded from aliphatic polyamides such as nylon 6, nylon 66 and nylon 612 tend to deform or crack when used for extended periods at high temperatures generated by motor vehicle engines and when exposed to chemicals such as salts and cooling fluids.

Semi-aromatic polyamide resin blends that exhibit greater dimensional stability in the presence of moisture, greater heat resistance, and greater chemical resistance are disclosed in EP 0 696 304 and EP 0 741 762. The compositions disclosed in these patents include semi-aromatic polyamide resins having an aromatic carboxylic acid component such as terephthalic acid or a mixture of terephthalic acid and isophthalic acid, and an aliphatic diamine component derived from a mixture of hexamethylene diamine and 2-methylpentamethylene diamine. Unfortunately, these resins cannot be used for making blow molded articles due to their low strength when in a molten state (melt strength), their rapid rate of crystallization, and their tendency to form bubbles during a blow molding process.

WO 02/083794 is directed to blow molded thermoplastic articles in which a pulp of short aramid fibers is incorporated into the thermoplastic. The possible thermoplastics listed include semi-aromatic polyamides, but without example or explanation as to how semi-aromatic polyamides can be made suitable for blow molding.

EP 0 505 162 discloses blow molded polyamide articles comprised of a blend of 50-90 wt. % polyamide 66, 5-40 wt. % polyamide 6T, and 3-30 wt. % polyamide 61. The addition of the polyamide 6T increases the temperature resistance of the resin but also accelerates the rate of crystallization. The polyamide 61 is added to slow the crystallization rate of the blend, making it more suitable for blow molding, without unduly reducing the temperature resistance. However, the disclosed polyamide 66—based blends have melting points of 260° C. or less, making them unsuitable for many high temperature applications. These blow molded articles optionally include other components such as fibrous reinforcing materials, elastomers, flame retarders, heat resisting agents, and antioxidants.

JP3085540B2 discloses articles blow molded from aromatic polyamide resins having a straight chain aliphatic diamine component unit and a dicarboxylic-acid component consisting of terephthalic acid and another aromatic dicarboxylic acid other than terephthalic acid. These aromatic polyamides are produced using conventional polymerization methods so as to achieve the relatively high viscosity needed for blow molding. For the disclosed aromatic polyamides, polymerization to high molecular weight is used to obtain a viscosity suitable for blow molding. However, such high molecular weight aromatic polyamides are time consuming and expensive to polymerize, and it is not possible to maintain the required viscosity through the compounding process, when other ingredients such as pigments or glass fibers are added to the composition, and through the blow molding process. This is because the introduction of even small amounts of moisture causes the disclosed aromatic polyamides to undergo depolymerization and become much more fluid.

High temperature polyamide compositions generally must include a thermal stabilizer to prevent deterioration of the composition during the melting phase of the blow molding process, and to allow the blow molded article to maintain its physical properties, such as tensile strength and impact strength, when operating in a high temperature environment over extended periods of time. The best thermal stabilization for high temperature polyamides are considered to be copper halide compounds. Unfortunately, copper halide compound stabilizers can cause decarboxylation of high temperature polyamides which results in the formation of carboxylic gas. This is a significant problem when a high temperature polyamide stabilized with copper halide compounds is used in a blow molding process because the polymer melt is extruded to form a parison at roughly atmospheric pressure. Upon extrusion into the lower pressure environment, carboxylic gas is formed in high temperature polyamide resins stabilized with copper-based stabilizers, which results in defects in the blow molded article that impair the appearance of the part and may impair the physical properties of the part as well. This is especially the case for relatively large blow molded parts because the formation of a larger molten parison provides more time for gas formation.

There is a need for blow moldable polyamide resin compositions that can be used to blow mold articles having excellent heat resistance, chemical resistance, dimensional stability, and mechanical properties, and that are suitable for a wide range of applications, including automobile parts, home appliances, tools, and furniture. There is a further need for high temperature semi-aromatic polyamide resin compositions that exhibit the viscosity, elasticity, melt strength and crystallization rate needed for blow molding of relatively large articles, and that are able to maintain these properties throughout a commercial compounding and blow molding processes. Finally, there is a need for blow molded high temperature polyamide articles that maintain their strength and stability at high temperatures, that are homogeneous, and that have a smooth surface appearance.

### Test Methods

In the description and the examples that follow, the following test methods were employed to determine various reported characteristics and properties. ISO refers to the International Organization for Standardization.

Melting temperature was measured according to ISO standard 3146C, and is reported in degrees Centigrade.

Glass transition temperature (Tg) was measured according to ISO standard 6721-5 by Dynamic Mechanical Analysis (DMA) using a DMA Viscoanalyser VA4000 from Metravib R.D.S., and is reported in degrees Centigrade.

Inherent viscosity was measured according to ISO standard 307 and is reported in units of dl/g.

Melt Flow Index was measured according to ISO standard 1133 at 325° C. using a 10 kg weight, and is reported in units of g/10 min.

Modulus is a measure of stiffness and was measured according to ISO standard 527-1/2, and is reported in units of GPa.

Strain at break was measured according to ISO standard 527-1/2 and is reported as a percent.

Stress at break was measured according to ISO standard 527-1/2 and is reported in units of MPa.

Crystallization Time is measured using a CAVAN cavity pressure analysis unit. The CAVAN measures pressure in an enclosed mold cavity during an injection molding cycle. Two pressure transducers are located in the mold cavity, one just a few millimeters from the injection gate and the other at the furthest point of flow from the injection gate. A computer connected to the pressure transducers records the pressure at the two transducers throughout the injection molding cycle. The computer generates a graph of pressure vs. time during the solidification of the polymer, and the crystallization time is defined as the time to reach the flexion point of this graph for the transducer furthest from the injection gate. The crystallization time is reported in seconds. This method is describe in X. Brouwers & E. Poppe, “Werkzeuginnendruck an Teilkristallinen Kunststoffen Messen”, KUNSTSTOFFE (Organ Deutscher Kunstoff-Farchverbande), February 1991.

### DEFINITIONS

The term “polymer” as used herein, generally includes but is not limited to, homopolymers, copolymers (such as for example, block, graft, random and alternating copolymers), terpolymers, etc. and blends and modifications thereof. Furthermore, unless otherwise specifically limited, the term “polymer” shall include all possible geometrical configurations of the material. These configurations include, but are not limited to isotactic, syndiotactic and random symmetries.

The term “EPDM” refers to ethylene propylene diene monomer elastomers and is used herein to mean any elastomer that is a terpolymer of ethylene, an alpha-olefin having from 3 to 10 carbon atoms, and a copolymerizable non-conjugated diene such as 5-ethylidene-2-norbornene, dicyclopentadiene, 1,4-hexadiene, and the like.

The term “EP” as used herein means any copolymer or terpolymer of ethylene and an alpha-olefin having from 3 to 10 carbon atoms, such as EPR, EPM, or an ethylene propylene copolymer.

### DETAILED DESCRIPTION

The present invention provides a polyamide resin composition for blow molding applications, articles blow molded from such compositions, and a process for blow molding articles from such compositions. The polyamide composition has a melting point of at least 275° C. and comprises:
(A) 40-90 weight percent, based on the total composition, of an aromatic polyamide polymer or copolymer having repeating units derived from a carboxylic acid component and an aliphatic diamine component, the carboxylic component being terephthalic acid or a mixture of terephthalic acid and one or more other carboxylic acids wherein the carboxylic acid component contains at least 55 mole percent, based on the carboxylic acid component, of terephthalic acid, and the aliphatic diamine component being hexamethylene diamine or a mixture of hexamethylene diamine and 2-methyl pentamethylene diamine or 2-ethyltetramethylene diamine, in which the aliphatic diamine component contains at least 40 mole percent, based on the aliphatic diamine component, of hexamethylene diamine;
(B) 0-25 weight percent, based on the total composition, of at least one aliphatic polyamide selected from the group consisting of polyamides containing repeat units derived from aliphatic dicarboxylic acids and aliphatic diamines, polyamides containing repeat units derived from aliphatic aminocarboxylic acids, and polyamides derived from lactams;
(C) 4-20 weight percent, based on the total composition, of an impact modifier selected from the group of (i) ethylene polymers and copolymers grafted with carboxylic acid, an anhydride thereof, maleimide or an epoxy compound; (ii) olefin/arcylic acid/anhydride terpolymers and ionomers; and (iii) styrenic thermoplastic elastomers grafted with an anhydride of a carboxylic acid;
(D) 0.3-5 weight percent, based on the total composition, of one or more stabilizers selected from the group of (i) phosphite and phosphonite stabilizers; (ii) hindered phenol stabilizers; (iii) hindered amine stabilizers; and (iv) aromatic amine stabilizers; and
(E) 0-40 weight percent, based on the total composition, of an inorganic reinforcing material.

More preferably, the polyamide composition for blow molding comprises:
(A) 60-80 weight percent, based on the total composition, of an aromatic polyamide polymer or copolymer having repeating units derived from a carboxylic acid component and an aliphatic diamine component, the carboxylic acid component being terephthalic acid or a mixture of terephthalic acid and one or more other carboxylic acids wherein the carboxylic acid component contains at least 55 mole percent, based on the carboxylic acid component, of terephthalic acid, and the aliphatic diamine component being hexamethylene diamine or a mixture of hexamethylene diamine and 2-methyl pentamethylene diamine or 2-ethyltetramethylene diamine, in which the aliphatic diamine component contains at least 40 mole percent, based on the aliphatic diamine component, of hexamethylene diamine;
(B) 0-25 weight percent, based on the total composition, of at least one aliphatic polyamide selected from the group consisting of polyamides containing repeat units derived from aliphatic dicarboxylic acids and aliphatic diamines, polyamides containing repeat units derived from aliphatic aminocarboxylic acids, and polyamides derived from lactams;
(C) 7-15 weight percent, based on the total composition, of an impact modifier selected from the group of (i) ethylene polymers and copolymers grafted with carboxylic acid, an anhydride thereof, maleimide or an epoxy compound; (ii) olefin/arcylic acid/anhydride terpolymers and ionomers; and (iii) styrenic thermoplastic elastomer grafted with maleic anhydride;
(D) 1-3 weight percent, based on the total composition, of one or more stabilizers selected from the group of (i) phosphite and phosphonite stabilizers; (ii) hindered phenol stabilizers; (iii) hindered amine stabilizers; and (iv) aromatic amine stabilizers; and
(E) 10-40 weight percent, based on the total composition, of reinforcing glass fibers.

The aromatic polyamide (A) consists of a polymer or copolymer having repeating units derived from a carboxylic acid component and an aliphatic diamine component. As used herein, the term aromatic polyamide refers to both fully aromatic and semi-aromatic polyamides. The carboxylic acid component is terephthalic acid or a mixture of terephthalic acid and one or more other carboxylic acids wherein the carboxylic acid component contains at least 55 mole percent, based on the carboxylic acid component, of terephthalic acid. Other carboxylic acids that may be used in the carboxylic acid component include isophthalic acid and adipic acid. The aliphatic diamine component is hexamethylene diamine or a mixture of hexamethylene diamine and 2-methyl pentamethylene diamine and/or 2-ethyltetramethylene diamine, in which the aliphatic diamine component contains at least 40 mole percent, based on the aliphatic diamine component, of hexamethylene diamine.

In the preferred aromatic polyamide, the carboxylic acid component is 100% terephthalic acid, and the aliphatic diamine component is a mixture of hexamethylene diamine and 2-methyl pentamethylene diamine, in which the aliphatic diamine component contains at least 40 to 90 mole percent, based on the aliphatic diamine component, of hexamethylene diamine. The asymmetric morphology of 2-methyl pentamethylene diamine with branched methyl group, when used in conjunction with the impact modifiers described below, results in compositions having desirable crystallization rates and melt strengths for use in blow molding. In an alternative aromatic polyamide, the aliphatic diamine component is 100% hexamethylene diamine, and the carboxylic acid component is a mixture of terephthalic acid and adipic acid wherein the carboxylic acid component contains at least 55 mole percent, based on the carboxylic acid component, of terephthalic acid. The aromatic polyamide should have a glass transition temperature in the range of 60° to 150° C., and more preferably 125° to 150° C. The inherent viscosity (“IV”) of the aromatic polyamide is preferably in the range of 0.9 dl/g to 1.1 dl/g, as measured at 23° C. in meta-cresol or concentrated sulfuric acid.

The composition may further include 0 to 25 weight percent of one or more additional aromatic polyamides such as polyamide 6T/6I, polyamide 6T/66, polyamide 6T/6I/66, polyamide 6/6T, polyamide 9T, polyamide 10T, polyamide 6I/6T/PACMI/PACMT, or polyamide TMDT.

The aforementioned aromatic polyamide resin may be manufactured by any known means, such as by polycondensation of terephthalic alone or in a mixture with isophthalic acid and/or adipic acid with hexamethylene diamine and/or 2-methyl pentamethylene diamine. Synthesis of 2-methyl pentamethylene diamine may be carried out by hydrogenation of the dinitrile of 2-methylglutaric acid. In similar manner, synthesis of 2-ethyl tetramethylene diamine may be carried out by the hydrogenation of the dinitrile of 2-ethyl succinic acid.

The aliphatic polyamide (B) may be any one or more of the known aliphatic polyamide polymers and copolymers commonly referred to as nylons, including polyamide 6, polyamide 66, polyamide 610, polyamide 612, polyamide 11, polyamide 46, polyamide 12, polyamide 1212, and polyamide 6/66. Methods for producing these aliphatic polyamide resins are well known, and include the condensation of equimolar amounts of saturated dicarboxylic acid containing 4 to 12 carbon atoms with a diamine, in which the diamine contains 4 to 14 carbon atoms. Excess diamine can be employed to provide an excess of amine end groups in the polyamide.

The impact modifier (C) is selected from the group of (i) ethylene polymers and copolymers grafted with carboxylic acid, an anhydride thereof, maleimide or an epoxy compound; (ii) olefin/arcylic acid/anhydride terpolymers and ionomers; and (iii) styrenic thermoplastic elastomers grafted with an anhydride of a carboxylic acid. The impact modifier can be used in neat or diluted form. In the latter case, either EPDM, EPR, or polyethylene can be used as the diluent.

In the ethylene polymers and copolymers grafted with carboxylic acid, an anhydride thereof, maleimide or an epoxy compound, the carboxylic acid or anhydride thereof is preferably selected from the group consisting of maleic acid, fumaric acid, itaconic acid, acrylic acid, crotonic acid, a C1-C4-alkyl half ester of maleic acid, and their anhydrides or derivatives, including maleic anhydride. Rubber-toughened polyamide compositions generally incorporate an olefinic rubber in the polyamide. Because olefinic rubbers are incompatible with polyamides, it is necessary to modify the rubber with functional groups that are capable of reacting with the acid or amine ends in the polyamide polymer. The reaction of an anhydride with amine is very fast, and therefore, an anhydride is often the functionality of choice. When an incompatible olefinic rubber with an anhydride functionality is mixed with a polyamide, the anhydride functionality of the rubber reacts with the amine ends of the polyamide resulting in the rubber becoming grafted on the polyamide molecule. Preferred impact modifiers are ethylene copolymers grafted with a carboxylic acid or any anhydride thereof, such as an ethylene copolymer grafted with maleic anhydride. Preferred impact modifiers for the polyamide blow molding compositions of the invention include maleic anhydride grafted EPDM (maleic anhydride from 0.2% to 6%, preferably from 0.5 to 3%); EP grafted with maleic anhydride (maleic anhydride from 0.5% to 6%, preferably from 1 to 3%); maleic anhydride grafted low density polyethylene (maleic anhydride from 0.2% to 6%, preferably from 0.5 to 3%); and ethylene butyl acrylate grafted with maleic anhydride (maleic anhydride from 0.2% to 6%, preferably from 0.5 to 3%).

The olefin/arcylic acid/anhydride terpolymer and ionomer impact modifiers have polymerized in-chain units derived from the monomers comprising: (a) ethylene, butylene, propylene, and combinations thereof; (b) 2 to 25 weight percent of an acid selected from the group of acrylic acid, methacrylic acid, and mixtures thereof; and (c) 0.1 to 15 weight percent of a dicarboxylic acid monomer selected from the group consisting of maleic acid, fumaric acid, itaconic acid, maleic anhydride, itaconic anhydride, a C1-C4-alkyl half ester of maleic acid, and a mixture of these dicarboxylic acid monomers. A preferred terpolymer for use in the blow molding polyamide compositions of the invention is an ethylene/methacrylic acid/maleic anhydride ionomer (from 0.5% to 12% maleic anhydride, preferably from 2 to 6%). The ionomer may be formed by neutralization of from about 5 to 90 percent of the total number of carboxylic acid units in the terpolymer with metal ions selected from the group of zinc, magnesium, manganese and mixtures thereof, alone or in combination with sodium or lithium ions. The terpolymer may further include up to 40 weight percent of C1-C8-alkyl alkyl acrylate monomer units.

The impact modifier that is a styrenic thermoplastic elastomer grafted with an anhydride of a carboxylic acid is preferably a styrene copolymer grafted with maleic anhydride such as styrene/ethylene-butylene/styrene grafted with maleic anhydride or styrene/isoprene grafted with maleic anhydride.

The combination of the aromatic high temperature polyamides described above and one or more of the above elastomeric impact modifiers provides a composition with the melt strength needed for blowing molding relatively large articles where the parison being blow molded is longer than 50 cm, 70 cm, or even longer than 100 cm, so as to produce articles of like dimensions. The addition of the above impact modifiers also improves elongation of the molten parison during the blow molding process. The presence of the impact modifiers improves the visco-elastic properties of the polymer composition such that after the high temperature polyamide parison is extruded during the blow molding process, it can be blown to a higher diameter without rupture of the parison. This is especially significant when relatively large articles are being blow molded from fiber reinforced polymer compositions, which are especially subject to rupture during the blow molding process. The preferred melt flow index for polyamide resins used for blow molding applications is in the range of 5 to 90 g/10 min, and more preferably in the range of 10 to 50 g/10 min. The melt flow index for the aromatic high temperature polyamide composition of Examples 1-4 was about 20 g/10 min.

The stabilizer (D) of the blow molding composition of the invention is a stabilizer selected from the group of phosphite and phosphonite stabilizers, hindered phenol stabilizers, hindered amine stabilizers and aromatic amine stabilizers. Such stabilizers function as process heat stabilizers and/or as product thermal stabilizers.

Phosphites and phosphonites stabilizers are trivalent phoshorus compounds such as sodium hypophosphite; tris(2,4-di-tert-butylphenyl)phosphite; bis(2,4-dicumylphenyl))pentaerythritol diphosphite; dibenzo[d,f][1,3,2]dioxaphosphepin, ethanamine deriv.; tetrakis(2,4-di-tert-butylphenyl)[1,1-biphenyl]-4,4′-diylbisphosphonite; tris(2,4-ditert-butylphenyl)phosphite; and 2,2-methylene-bis(4,6-di-tert-butylphenyl)octylphosphite.

Hindered phenols stabilizers are aromatic products containing OH groups and are sterically hindered by bulky aliphatic side chains. Examples of hindered phenol stabilizers include pentaerythritol tetrakis(3-(3,5-di-tert-butyl-4 hydroxyphenyl)propionate); N—N′-hexane-1,6-diylbis(3-(3,5-di-tert-butyl-4-hydroxyphenylpropionamide)); and ethylenebis(oxyethylene)bis(3-(5-tert-butyl-4-hydroxy-m-tolyl)-propionate).

Hindered amine stabilizer are tetramethyl piperidine derivatives that are sterically hindered by bulky aliphatic side chains. Examples of hindered amine stabilizers include poly[[6-[(1,1,3,3-tetramethylbutyl)amino]-1,3,5-triazine-2,4-diyl][(2,2,6,6-tetramethyl-4-piperidinyl)imino]-1,6-hexanediyl[(2,2,6,6-tetramethyl-4-piperidinyl)imino]]); butanedioic acid, dimethylester,polymer with 4-hydroxy-2,2,6,6-tetramethyl-1-piperidine ethanol; and bis (2,2,6,6,-tetramethyl-4-piperidyl)sebaceate.

Aromatic amine stabilizers are secondary aromatic amines. Examples of aromatic amine stabilizers include 4,4′ bis(alpha, alpha dimethylbenzyl)diphenylamine; and N,N′-diphenyl-1,4-phenylendiamine.

The preferred stabilizers are a combination of phosphite stabilizer, hindered phenol stabilizer, and hindered amine stabilizer. It has surprisingly been found that when such a combination of stabilizers is used in the blow molding composition of the invention, blow molded articles so stabilized are able maintain physical properties (such as impact resistance and tensile strength) after heat aging that are equivalent to the properties of polyamide articles stabilized with copper halide compounds. This can be seen in the examples below when comparing the heat aging results of Comparative Example B with those of Examples 1-4.

The inorganic reinforcing material (E) of the blow molding composition of the invention is preferably one or more of glass fibers, glass beads, glass flakes, carbon fibers or other fibers such as Kevlar® brand fiber or Kevlar® pulp, mineral whiskers, wollastonite, kaolin or clay. More preferably, the reinforcing material is glass fibers having an average diameter of about 10 microns. The reinforcing material, in combination with the other components of the blow molding compositions of the invention, serve to enhance the mechanical properties of the molded articles, including higher stiffness, greater impact resistance, and higher tensile strength.

So long as the properties needed for blow molding are not degraded, the polyamide blow molding resin composition of the invention may include minor amounts of additional additives, such as plasticizers, dyes, pigments, fillers, fire retardants, processing aids, and mold release agents.

The blow molding composition of the invention has a melting point of at least 275° C., and more preferably at least 285° C., and most preferably at least 300° C. In addition, the blow molding composition of the invention has a glass transition temperature (Tg) of at least 60° C., and more preferably of at least 80° C., and most preferably of at least 120° C.

Crystallization rate is a function of the time required for a semicrystalline polymer, such as a polyamide, to crystallize. It is important in a blow molding process that the crystallization rate not be too fast or too slow. If the crystallization rate is too fast, the parison can rupture during blowing, the pinch off area may be poorly formed, or surface defects may develop in the blow molded article. Unduly rapid crystallization is especially troublesome for relatively large blow molded articles where it takes more time to form the larger parison. Where crystallization is too slow, the period required to mold each article is long, making the process uneconomical. Relative crystallization rates of various polymer resins can be measured using the CAVAN method described above. By this method, nylon 6 has a crystallization time of about 18 seconds, and nylon 66 used in blow molding has a crystallization time of about 10.5 seconds. A high temperature aromatic polyamide for injection molding in which the carboxylic acid component is 100% terephthalic acid, and the aliphatic diamine component is a mixture of hexamethylene diamine and 2-methyl pentamethylene diamine, in which the aliphatic diamine component contains at least 40 to 90 mole percent of hexamethylene diamine, based on the aliphatic diamine component, has a crystallization time of about 10 seconds. It can be seen in the examples below that the high temperature semi-aromatic polyamide compositions of the invention have desirable crystallization times of 12 to 14 seconds. While it is desirable that aromatic high temperature polyamide compositions for blow molding have a crystallization speed that is not too fast, it is also desirable that the composition have good melt strength.

For preparing the blow molded articles of the invention, a conventional blow molding process can be used with the polyamide blow molding compositions described above. Modified blow molding processes, such as suction blow molding or injection blow molding, may also be used to produce blow molded articles from the polyamide blow molding compositions described above.

### EXAMPLES

The invention is further illustrated by the following examples. It will be appreciated that the examples are for illustrative purposes only and are not intended to limit the invention as described above. Modification of detail may be made without departing from the scope of the invention.

### Composition Components

The individual components in the blow molding compositions described in the examples below were as follows:

Polyamide 6T/XT is an aromatic polyamide derived from a carboxylic acid component that is 100% terephthalic acid, and the aliphatic diamine component that is a mixture of hexamethylene diamine and 2-methyl pentamethylene diamine, available under the tradename Zytel® HTN 501 from E.I. du Pont de Nemours and Company (“DuPont”).

Polyamide 66 is an aliphatic polyamide 66 available from DuPont under the tradename Zytel® 101.

Impact Modifier (a) is a maleic anhydride functionalized EPDM rubber available from DuPont under the tradename FUSABOND® N MF521D.

Impact Modifier (b) is a terpolymer of ethylene, methacrylic acid, and a half ester of maleic anhydride available from DuPont under the name Surlyn® AD 1002.

Impact Modifier (c) is linear low density polyethylene grafted with maleic anhydride available from DuPont under the tradename Fusabond MB226D.

Impact Modifier (d) is an ethylene n-butylacrylate copolymer available from DuPont under the tradename Elvaloy® 1820AC.

Glass Fibers are E-glass, G-filament, approximately 10 micron diameter, approximately 3 mm length, amino-silane coated glass fibers.

Copper Stabiliser is a copper halide based inorganic heat stabilizer.

Chimasorb 944 is an oligomeric hindered amine light stabiliser: Poly[[6-[(1,1,3,3-tetramethylbutyl)amino]-1,3,5-triazine-2,4-diyl][(2,2,6,6-tetramethyl-4-piperidinyl)imino]-1,6-hexanediyl[(2,2,6,6-tetramethyl-4-piperidinyl)imino]]).

Irgafos P-EPQ is a phosphonite processing stabilizer: Tetrakis(2,4-di-tert-butylphenyl)[1,1-biphenyl]-4,4′-diylbisphosphonite.

Irgafos 168 is a phosphite processing stabilizer: Tris(2,4-ditert-butylphenyl)phosphite.

Irgafos 12 is a phosphite processing stabilizer, dibenzo[d,f][1,3,2]dioxaphosphepin, ethanamine deriv.

Irganox 1098 is a phenolic primary antioxidant for processing and long-term thermal stabilization: N—N′-hexane-1,6-diylbis(3-(3,5-di-tert-butyl-4-hydroxyphenylpropionamide)).

Irganox 1010 is a sterically hindered phenolic primary antioxidant for processing and long term thermal stabilization: pentaerythritol tetrakis(3-(3,5-di-tert-butyl-4-hydroxyphenyl)propionate)

Carbon Black is a masterbatch of 25% carbon black in polyamide 6.

The compositions of the examples were made by compounding the components using a laboratory scale twin screw extruder, wherein the temperature of the melt was 340° C., the screw speed was 250 rpm and the average volumetric flow rate was 100 kg/hr. The compositions of the examples and a number of their properties are set forth below in Table 1.

Injection molded test bars of each composition were produced for testing of mechanical properties after various periods of heat aging. The properties of the samples made from each composition were measured at room temperature and where subsequently measured again at room temperature after heat aging at 180° C. for 72 hours, 2000 hours, and 3000 hours. The mechanical properties are reported in Table 2.

Blow molding evaluations of the compositions were conducted on a Battenfeld Fischer continuous extrusion blow molding machine equipped with a screw having 60 mm diameter and 1200 mm length. The screw was turned at 40 rpm and the temperature of the extruder was maintained so as to heat the melt to 325° C. at the die. The parison was extruded through a circular die with an outer diameter of 28 mm and a core pin diameter of 21 cm. The melt was extruded to form a hollow parison that was filled with air so as to maintain the hollow shape. The parison was allowed to drop about 70 cm at which time the mold was closed so as to cut the parison and seal the parison at both ends. A gas pin was immediately inserted into the sealed hollow parison and air was blown into the parison at a pressure of approximately 10 bar to expand the parison against the interior walls of the mold cavity. After passage of a sufficient time for crystallization of the resin (approximately 15 seconds), the mold was opened and the part was removed.

No article could be blow molded with the composition of Comparative Example A because the polymer melt lacked the strength needed for formation of a parison. Blow molded articles having a smooth and homogeneous surface appearance were successfully produced from the resin compositions of Examples 1-7. However, the article blow molded from the composition of Comparative Example B, which included a copper-based stabilizer, had a severely blistered and rough appearance.

The melt strength of the compositions of the invention were studied using a parison drop test and were characterized in terms of a Sag Ratio. In the parison drop test, molten parisons were extruded as described in the previous paragraph. However, only the descent of the extruded parison was measured without closing the mold. During its descent from the die towards the floor, the advance of the parison was measured in the following way: the parison was cut at the die exit and this defined the time as zero, then the time was recorded when the lowest point of the parison had moved by 0.2 m below the die (T_{0.2}), and then when it has moved by 1 m below the die (T₁). Four such measurements were made and the average times were used to calculate the Sag Ratio (SR) for the composition, which is defined as:
SR=(0.2)T₁/T_{0.2}

A thermoplastic polymeric matrix with no sag would have a constant parison drop speed, hence a sag ratio equal to one. Therefore, the closer the SR is to the value 1, the higher is the melt strength of the composition as a parison. This is especially important for the production of relatively large blow molded articles which require a long parison capable of significant expansion. The Sag Ratio for the compositions is reported in Table 1.

TABLE 1

| | Example | | | | | | | | | |
|---|---|---|---|---|---|---|---|---|---|---|
| | Comp. | | | | | Comp. | | | Comp. | |
| | Ex. A | Ex. 1 | Ex. 2 | Ex. 3 | Ex. 4 | Ex. B | Ex. 5 | Ex. 6 | Ex. C | Ex. 7 |
| Composition (wt. %) | | | | | | | | | | |
| Polyamide 6T/XT | 64 | 70.25 | 70.95 | 70.25 | 70.25 | 70.25 | 75.65 | 71.65 | 71.65 | 50.65 |
| Polyamide 66 | | | | | | | | | | 20 |
| Impact Modifier (a) | | 10.0 | 10.0 | 10.0 | 10.0 | 10.0 | | | | 10 |
| Impact Modifier (b) | | | | | | | 6 | | | |
| Impact Modifier (c) | | | | | | | | 10 | | |
| Impact Modifier (d) | | | | | | | | | 10 | |
| Glass Fibers | 35 | 17.5 | 17.5 | 17.5 | 17.5 | 17.5 | 17.5 | | | 17.5 |
| Copper Stabilizer | 0.4 | | | | | 0.4 | | | | |
| Chimasorb 944 | | 0.6 | 0.3 | 0.6 | 0.6 | | | | | |
| Irgafos P-EPQ | | 0.4 | 0.2 | | | | | | | 0.4 |
| Irgafos 168 | | | | 0.4 | | | | | | |
| Irgafos 12 | | | | | 0.4 | | | | | |
| Irganox 1098 | | 0.4 | 0.2 | 0.4 | 0.4 | 0.75 | | | | 0.4 |
| Irganox 1010 | | 0.25 | 0.25 | 0.25 | 0.25 | 0.25 | 0.25 | 0.25 | 0.25 | 0.25 |
| Carbon Black | 0.6 | 0.6 | 0.6 | 0.6 | 0.6 | 0.6 | 0.6 | 0.6 | 0.6 | 0.8 |
| Properties (composition) | | | | | | | | | | |
| Melting Temp. (° C.) | 303 | 303 | 303 | 303 | 303 | 303 | | | | 281 |
| Glass Transition - Tg. (° C.) | 135 | 135 | 135 | 135 | 135 | | | | | 90 |
| Crystallization Time (sec.) | 10.7 | 12.0 | 12.0 | 12.2 | 12.2 | 12.3 | 12.2 | 12.0 | 11.8 | 14.4 |
| Melt Flow Index | | 20 | 20 | 20 | 20 | | | | | |
| Sag Ratio | NA | 0.81 | 0.81 | 0.79 | 0.79 | | 0.65 | 0.62 | 0.37 | 0.80 |

TABLE 2

| | Example | | | | | | | | | |
|---|---|---|---|---|---|---|---|---|---|---|
| | Comp. | | | | | Comp. | | | Comp. | |
| | Ex. A | Ex. 1 | Ex. 2 | Ex. 3 | Ex. 4 | Ex. B | Ex. 5 | Ex. 6 | Ex. C | Ex. 7* |
| No Heat Aging | | | | | | | | | | |
| Tensile Modulus (GPa) | 12.1 | 6.1 | 6.0 | 6.0 | 5.8 | 6.1 | 6.7 | 6.1 | 6.5 | 5.8 |
| Stress at Break (MPa) | 212 | 122 | 123 | 123 | 125 | 119 | 136 | 135 | 104 | 129 |
| Strain at Break (%) | 2.3 | 3.0 | 3.3 | 3.3 | 3.3 | 3.3 | 2.6 | 3.6 | 1.8 | 3.4 |
| 72 hours @ 180° C. | | | | | | | | | | |
| Tensile Modulus (GPa) | 11.0 | 5.5 | 5.7 | 6.1 | 5.7 | 5.9 | 6.2 | 6.3 | 6.3 | 5.8 |
| Stress at Break (MPa) | 188 | 111 | 117 | 120 | 122 | 136 | 122 | 114 | 91 | 111 |
| Strain at Break (%) | 1.8 | 2.4 | 2.6 | 2.6 | 2.7 | 3.2 | 2.1 | 2.1 | 1.5 | 2.4 |
| 2000 hours @ 180° C. | | | | | | | | | | |
| Tensile Modulus (GPa) | 13.0 | 6.6 | 6.7 | 6.6 | 6.6 | 6.7 | 6.9 | 6.8 | 7.1 | 5.4 |
| Stress at Break (MPa) | 155 | 71 | 74 | 75 | 71 | 81 | 78 | 82 | 78 | 68 |
| Strain at Break (%) | 1.6 | 1.4 | 1.6 | 1.5 | 1.4 | 1.7 | 1.4 | 1.6 | 1.3 | 1.5 |
| 3000 hours @ 180° C. | | | | | | | | | | |
| Tensile Modulus (GPa) | 13.0 | 6.8 | 6.8 | 6.7 | 6.6 | 6.9 | 7.3 | 6.8 | 7.3 | |
| Stress at Break (MPa) | 138 | 66 | 69 | 67 | 64 | 68 | 61 | 66 | 65 | |
| Strain at Break (%) | 1.4 | 1.3 | 1.4 | 1.3 | 1.3 | 1.4 | 1.3 | 1.3 | 1.3 | |

*Temperature aging conducted @185° C.

1.-20. (canceled)

21. A blow molded article comprising a polyamide resin composition, comprising:
40-90 weight percent, based on the total composition, of an aromatic polyamide polymer or copolymer having repeating units derived from a carboxylic acid component and an aliphatic diamine component, the carboxylic component being terephthalic acid or a mixture of terephthalic acid and one or more other carboxylic acids wherein the carboxylic acid component contains at least 55 mole percent, based on the carboxylic acid component, of terephthalic acid, and the aliphatic diamine component being hexamethylene diamine or a mixture of hexamethylene diamine and 2-methyl pentamethylene diamine or 2-ethyltetramethylene diamine, in which the aliphatic diamine component contains at least 40 mole percent, based on the aliphatic diamine component, of hexamethylene diamine;
4-20 weight percent, based on the total composition, of an impact modifier selected from the group consisting of (i) ethylene polymers and copolymers grafted with carboxylic acid, an anhydride thereof, maleimide or an epoxy compound; (ii) olefin/arcylic acid/dicarboxylic acid terpolymers and ionomers; and (iii) styrenic thermoplastic elastomers grafted with an anhydride of a carboxylic acid;
0.3-5 weight percent, based on the total composition, of one or more stabilizers selected from the group consisting of (i) phosphite and phosphonite stabilizers; (ii) hindered phenol stabilizers; (iii) hindered amine stabilizers; and
(iv) aromatic amine stabilizers;
said composition having a melting point of at least 275° C. and a glass transition temperature of at least 60° C.

22. The blow molded article of claim 21 wherein in the aromatic polyamide polymer or copolymer having repeating units derived from a carboxylic acid component and an aliphatic diamine component, the carboxylic acid component is 100% terephthalic acid.

23. The blow molded article of claim 21 wherein in the aromatic polyamide polymer or copolymer having repeating units derived from a carboxylic acid component and an aliphatic diamine component, the aliphatic diamine component is a mixture of hexamethylene diamine and 2-methyl pentamethylene diamine, in which the aliphatic diamine component contains at least 40 to 90 mole percent, based on the aliphatic diamine component, of hexamethylene diamine.

24. The blow molded article of claim 23 wherein the impact modifier is an ethylene polymer or copolymer grafted with maleic anhydride.

25. The blow molded article of claim 21, further comprising 1-40 weight percent, based on the total composition, of an inorganic reinforcing material.

26. The blow molded article of claim 25 wherein the inorganic reinforcing agent includes glass fibers present in the composition in an amount of 10 to 40 weight percent of the composition.

27. The blow molded article of claim 21, wherein the composition has a melting point of at least 285° C. and a glass transition temperature of at least 80° C.

28. The blow molded article of claim 21, wherein the composition has a melting point of at least 300° C. and a glass transition temperature of at least 120° C.

29. The blow molded article of claim 1, further comprising 4 to 25 weight percent, based on the total composition, of at least one aliphatic polyamide selected from the group consisting of polyamides containing repeat units derived from aliphatic dicarboxylic acids and aliphatic diamines, polyamides containing repeat units derived from aliphatic aminocarboxylic acids, and polyamides derived from lactams.

30. The blow molded article of claim 21 wherein the composition has a melt flow index of at least 5 g/10 min and a Sag Ratio of at least 0.5.

31. A blow molded article comprising a composition comprising:
60-80 weight percent, based on the total composition, of an aromatic polyamide polymer or copolymer having repeating units derived from a carboxylic acid component and an aliphatic diamine component, the carboxylic component being terephthalic acid or a mixture of terephthalic acid and one or more other carboxylic acids wherein the carboxylic acid component contains at least 55 mole percent, based on the carboxylic acid component, of terephthalic acid, and the aliphatic diamine component being hexamethylene diamine or a mixture of hexamethylene diamine and 2-methyl pentamethylene diamine or 2-ethyltetramethylene diamine, in which the aliphatic diamine component contains at least 40 mole percent, based on the aliphatic diamine component, of hexamethylene diamine;
7-15 weight percent, based on the total composition, of an impact modifier selected from the group consisting of (i) ethylene polymers and copolymers grafted with carboxylic acid, an anhydride thereof, maleimide or an epoxy compound; (ii) olefin/arcylic acid/dicarboxylic acid terpolymers and ionomers; and
(iii) styrenic thermoplastic elastomer grafted with maleic anhydride;
1-3 weight percent, based on the total composition, of one or more stabilizers selected from the group consisting of (i) phosphite and phosphonite stabilizers; (ii) hindered phenol stabilizers; (iii) hindered amine stabilizers; and (iv) aromatic amine stabilizers; and
15-35 weight percent, based on the total composition, reinforcing glass fibers.

32. The blow molded article of claim 21 wherein the article has a length in at least one direction of at least 50 cm.

33. The blow molded article of claim 32 wherein the article has a length in at least one direction of at least 70 cm.

34. A blow molded article comprised of the composition of claim 31 wherein the article has a length in at least one direction of at least 70 cm.

35. A process for making a blow molded polyamide article, comprising the steps of:
forming a melt of the composition comprising
40-90 weight percent, based on the total composition, of an aromatic polyamide polymer or copolymer having repeating units derived from a carboxylic acid component and an aliphatic diamine component, the carboxylic component being terephthalic acid or a mixture of terephthalic acid and one or more other carboxylic acids wherein the carboxylic acid component contains at least 55 mole percent, based on the carboxylic acid component, of terephthalic acid, and the aliphatic diamine component being hexamethylene diamine or a mixture of hexamethylene diamine and 2-methyl pentamethylene diamine or 2-ethyltetramethylene diamine, in which the aliphatic diamine component contains at least 40 mole percent, based on the aliphatic diamine component, of hexamethylene diamine;
4-20 weight percent, based on the total composition, of an impact modifier selected from the group consisting of (i) ethylene polymers and copolymers grafted with carboxylic acid, an anhydride thereof, maleimide or an epoxy compound; (ii) olefin/arcylic acid/dicarboxylic acid terpolymers and ionomers; and (iii) styrenic thermoplastic elastomers grafted with an anhydride of a carboxylic acid;
0.3-5 weight percent, based on the total composition, of one or more stabilizers selected from the group consisting of (i) phosphite and phosphonite stabilizers; (ii) hindered phenol stabilizers; (iii) hindered amine stabilizers; and
(iv) aromatic amine stabilizers;
said composition having a melting point of at least 275° C. and a glass transition temperature of at least 60° C.;
extruding said melt through a die to form a hollow parison;
positioning the hollow parison within a mold cavity;
sealing the ends of the parison;
injecting air into the parison so as to expand the parison to conform to the interior surface of the mold cavity;
cooling the parison so as to solidify into a blow molded article; and
opening the mold and removing the blow molded article from the mold cavity.

36. The process of claim 35 wherein the parison has a Sag Ration of at least 0.5.

37. The process of claim 35 wherein the parison is at least 50 cm long.

38. The process of claim 35 wherein the steps of positioning the hollow parison within a mold cavity and sealing the end of the parison are accomplished by closing a mold having a mold cavity around the parison so as to seal the ends of the parison.

39. The process of claim 35 wherein the melt is extruded directly into a mold cavity and a vacuum is applied to the mold cavity so as to suck the parison into the mold cavity before air is injected into the parison.
